(19) United States
(12) Patent Application Publication
(10) Pub. No.: US 2018/0297896 A1
(43) Pub. Date: Oct. 18, 2018

(54) INFRARED (IR)-REFLECTING COMPOSITION AND INFRARED (IR)-REFLECTING BUILDING MATERIALS

(71) Applicant: MIG MATERIAL INNOVATIVE GESELLSCHAFT MBH, Salzkotten (DE)

(72) Inventors: Burkhard BRANDT, Paderborn (DE); Wolfgang BONDER, Salzkotten (DE)

(21) Appl. No.: 15/525,830

(22) PCT Filed: Nov. 3, 2015
(86) PCT No.: PCT/EP2015/075525

§ 371 Date: May 10, 2017

(30) Foreign Application Priority Data
Nov. 10, 2014 (DE) 20 2014 105 390.5

(51) Int. Cl. C04B 20/10; C03C 17/06; C03C 11/00; C03C 12/02; C04B 28/02; E04C 2/26

(52) U.S. Cl. CPC C04B 20/1062; C03C 17/06; C03C 11/002; C04B 2111/00482; C04B 28/02; E04C 2/26; C03C 12/02

(57) ABSTRACT

The invention relates to an IR-reflecting composition that features a mixture of glass components selected from the group comprising hollow glass balls, full glass balls, hollow glass balls coated with silver, full glass balls coated with silver, hollow glass balls coated with aluminum and full glass balls coated with aluminum. The subject of the invention are further also construction materials which feature a coating that contains the IR-reflecting composition.

The invention relates to an IR-reflecting composition. The subject of the invention are further also construction materials which feature a coating that contains the IR-reflecting composition.

### PRIOR ART AND TECHNOLOGICAL BACKGROUND

The Chinese already knew over 3,000 years ago that heat radiation has a positive effect on treating the human body for ailments. During the last 20 years, it has also been observed that people respond particularly well to IR radiation from the close infrared range (IR-A 780 nm to 1400 nm and IR-B 1400 nm to 3000 nm). If this radiation is introduced into rooms, an optimal environment is created there that has a particularly beneficial effect on health, concentration, increase in ability to learn, and relaxation.

The range of medical effects of IR radiation is broad. The indications include acute or chronic muscle pain, rigidity of the muscles and joints arising from different causes (with the exception of acute inflammatory processes), circulation problems, deep-seated problems in the lumbar spine, sprains, hematomas, and as preparation for other therapeutic measures such as massages. However, red light is also useful when treating chronic infections beyond an acute episode. These include rheumatic diseases, chronic bronchitis, sinusitis, prostatitis, and scleroderma. Additionally, IR-A applications can also help fight peripheral circulation problems and complex regional pain syndrome. Other areas of application are allergies and various other dermatological diseases, neurological illnesses such as post-poliomyelitis syndrome, and a general immunological defense weakness.

Aside from these effects, the anti-inflammatory effects of the radiation have also been proven. These are connected in particular with changes in the prostaglandin pattern of the tissue being irradiated, among other things with the increase in PG 12. Additionally, the level of oxidative stress in the warmed tissue appears to decrease.

Heat prevents and reduces pain by relaxing muscles and joints. Also, heat is perceived in the skin and in the tissue by thermosensors. When the regional temperature of warmed body areas exceeds the body's core temperature (39.6 degrees Celsius), the body increases blood circulation in order to cool the overheated areas. The improved blood circulation then increases the supply of oxygen and substrates for regeneration and healing processes, and improves the removal of carbon dioxide and metabolic products, as well as stimulating many metabolic processes.

At the same time, it has been shown that the room climate also alters in a positive way when IR radiation A is present in sufficient quantities with a sufficient share of B. The use of IR-reflective materials, such as hollow glass balls and reflecting pigments, is known in different carrier systems for coating walls and construction materials. However, the reflection of these additives is not sufficient, in particular for the close IR wavelength range of the known formulations. The contribution to a sense of wellbeing and the resulting health benefits for the individual in the rooms is therefore considerably reduced.

### ABSTRACT OF THE INVENTION

One or more of the problems described can be rectified or at least reduced with the aid of the IR-reflecting composition according to the invention. It was found that by means of a mixture of glass systems present in the form of hollow glass balls, full glass balls and in some cases with a coating of silver and/or aluminum, the wavelength areas of the close IR range are particularly well reflected. The mixture is therefore particularly suited for reflecting the IR wavelength area A of 780 nm to 1400 nm and the IR wavelength B of 1400 to 3000 nm. The mixture of the glass components can be equipped with further supplements, and used for example for coating construction materials such as gypsum fiberboard panels and construction panels of all types.

According to the invention, the IR-reflecting composition is therefore a mixture of glass components selected from the group comprising hollow glass balls, full glass balls, hollow glass balls coated with silver, full glass balls coated with silver, hollow glass balls coated with aluminum and full glass balls coated with aluminum.

Preferably, the IR-reflecting composition is characterized by the fact that it features a mixture of the glass components hollow glass balls, full glass balls, hollow glass balls coated with silver, full glass balls coated with silver, hollow glass balls coated with aluminum and full glass balls coated with aluminum. In other words, according to this preferred embodiment, all glass components are contained in the mixture. This preferred composition reflects radiation in the near infrared range particularly well.

The uncoated and coated hollow glass balls and full glass balls preferably feature a diameter of 10 to 200 μm. They are commercially available, e.g. from 3M.

The hollow glass balls and full glass balls coated with silver and/or aluminum preferably have a weight proportion of 1 to 75 weight % in relation to 100 weight % of the mixture (i.e. in relation to the entire weight of the glass components of the mixture).

The IR-reflecting composition of a combination of different glass components can further contain fillers, pigments and/or carrier materials. These are preferably selected from the group comprising dispersants, defoamers, binding agents, thickening agents, sheet silicates, titanium oxide, carbonates, silica gel, diatomite, silicates, amphiboles, talcum, kaolin, attaclay, cement, limestone, lime, chalk, loess, clay, dolomite, diatomaceous earth, attapulgite, montmorillonite, bentonite, volcanic ashes, mica, vermiculite, synthetic silicic acids, rice husk ash, amorphous glass structures, amorphous silicic acids and synthetic calcium silicates, aluminosilicates, biominerals (nacre) and anorganic color pigments. In particular, the composition contains mica, cement, diatomite, montomorillonite or amorphous glass particles.

In a particularly preferred manner, an IR-reflecting composition with
1 to 20 weight %, in particular 10.5 weight %, hollow glass balls with a diameter of 1 to 90 μm;
1 to 20 weight %, in particular 12 weight %, hollow glass balls with a diameter of 10 to 90 μm coated with silver; and
2 to 25 weight %, in particular 20 weight %, titanium oxide as a filler (weight % related respectively to the composition).

In a particularly preferred manner, the composition additionally contains 1 to 25 weight %, preferably 21.5 weight %, calcium carbonate with a grading curve of 10 to 4000 μm as a filler. The composition permits an almost complete reflection of the near IR range.

A further preferred variant of the IR-reflecting composition contains
12.5% hollow glass balls with a diameter of 0.5 to 50 μm;
7.5% hollow glass balls coated with aluminum with a diameter of 0.5 to 50 μm;
1.25% hollow glass balls coated with silver with a diameter of 0.5 to 50 μm;
25% full glass balls with a diameter of 0.5 to 70 μm;
7.5% full glass balls coated with aluminum with a diameter of 0.5 to 70 μm;
3.5% full glass balls coated with silver with a diameter of 0.5 to 70 μm; and
42.75% mica (0.5 to 200 μm).

Additionally, a further preferred variant of the IR-reflecting composition contains
8.5% hollow glass balls with a diameter of 0.5 to 170 μm;
12% hollow glass balls coated with aluminum with a diameter of 0.5 to 170 μm;
5% hollow glass balls coated with silver with a diameter of 0.5 to 170 μm;
35% full glass balls with a diameter of 0.5 to 150 μm;
2.5% full glass balls coated with aluminum with a diameter of 0.5 to 150 μm;
5.5% full glass balls coated with silver with a diameter of 0.5 to 150 μm;
10% titanium oxide; and
21.5% mica (0.5 to 200 μm).

Further, it is preferred when the two above variants of the compositions are mixed at a ratio of 2:1 to 3:1, in particular 3:1.

The IR-reflecting composition is produced professionally from a combination of different glass components, usually through simple mixing of the components.

A further aspect of the invention relates to IR-reflecting construction materials that feature a coating which contains the IR-reflecting composition described above, or which consists of such a composition.

Preferably, the coating contains a binding system, in particular a binding agent based on acrylate, vinyl acetate or silicon resin, cement, plaster, plaster anhydride, a latent hydraulic binding agent, water glass, bitumen, clay, a ceramic binding agent, or lignin and its derivatives.

The construction materials are preferably selected from the group comprising calcium silicate panels, gypsum panels, insulation panels, XPS panels, hard foam panels, Promat panels, gypsum board construction panels GBP, eternit, LUX elements, plasterboard construction panels, KNAUF construction panels, Fermacell, Phonewall panels, KS construction panels, gypsum fiberboard panels, wood panels, wood fiber panels, impregnated gypsum board panels, panels, tiles, WEDI panels, acrylic glass panels, porous concrete panels, brick panels, cement-bonded construction panels, vermiculite panels and perlite panels, foam glass, panels based on regenerative materials (such as bulrush plants or sweet grasses ((poaceae)), bisulfite panels, noise-reducing panels, magnesia binders, asphalt, tar and bitumen.

The IR-reflecting compositions can accordingly be easily integrated into construction materials such as construction panels, i.e. they can in particular be equipped with an IR-A and IR-B reflective coat.

### BRIEF DESCRIPTION OF THE FIGURES

The one FIGURE shows the progress of the degree of reflection in % compared to the wavelength in the near IR range of an IR-reflective composition according to a variant of the invention.

### DETAILED DESCRIPTION OF THE INVENTION

The invention will be explained below in greater detail with reference to exemplary embodiments.

### Example 1

Preferred composition, suitable in particular for applications to reflect the entire close IR range using gypsum board panels. It is composed of the following:

10.5% hollow glass balls with a diameter of 1 to 90 μm

12% hollow glass balls with a diameter of 10 to 90 μm, coated with silver

5.5% full glass balls coated with silver

13.8% mica

0.5% dispersant (Ciba)

0.5% Dehydran 1620 (Cognis)

0.5% propylene carbonate (Merck)

0.2% Walocel MKX 20000 PF 40 (Wolf Cellul. AG)

0.5% Wallatrop S (Osthoff-Petrasch GmbH)

14.5% Mowelith 1871

20% titanium dioxide

21.5% filler, e.g. calcium carbonate, with a grading curve of 10 to 4000 μm.

### Example 2

Preferred compositions that demonstrate a good reflection of the IR radiation in the A range of 780 to 1,400 nm and in the B range of 1,400 to 3,000 nm:

a) Composition 1:

12.5% hollow glass balls with a diameter of 0.5 to 50 μm

7.5% hollow glass balls coated with aluminum

25% full glass balls with a diameter of 0.5 to 70 μm

3.5% full glass balls coated with silver

7.5% full glass balls coated with aluminum

1.25% hollow glass balls coated with silver

42.75% filler (mica with a diameter of 0.5 to 200 μm).

When irradiated with IR light in wavelength ranges A, B and C, 91.5% of the wavelength

ranges IR-A and IR-B were reflected.

b) Composition 2:

8.5% glass hollow balls with a diameter of 0.5 to 170 μm

12% hollow glass balls coated with aluminum

5% hollow glass balls coated with silver

35% full glass balls with a diameter of 0.5 to 150 μm

5.5% full glass balls coated with silver

2.5% full glass balls coated with aluminum

10% titanium dioxide

21.5% filler (mica with a diameter of 0.5 to 200 μm).

Composition 2 reflects the IR-A range up to 60% and the IR-B range up to 29%.

### Example 3

A further IR-reflecting composition suitable for coating comprises a combination of the compositions according to Composition 1 and 2, wherein in Composition 3, 1:1 surplus is present.

### Example 4

Standard composition for coating using the composition according to Example 3, which is composed as follows (data in weight %):

26.6 water

0.5 dispersant (Ciba)

0.5 Dehydran 1620 (Cognis)

0.5 Propylene carbonate (Merck)

0.2 Walocel MKX 20000 PF 40 (Wolf Cellul. AG)

0.5 Wollatrop S (Osthoff-Petrasch GmbH)

Omyacarb 2GU (Omya GmbH)

Omyacarb 5GU (Omya GmbH)

4.7 titanium dioxide RDI-S (Kemira)

Mowilith 1871 (Celanese AG)

21.5 composition according to Example 3

water for adjusting the viscosity.

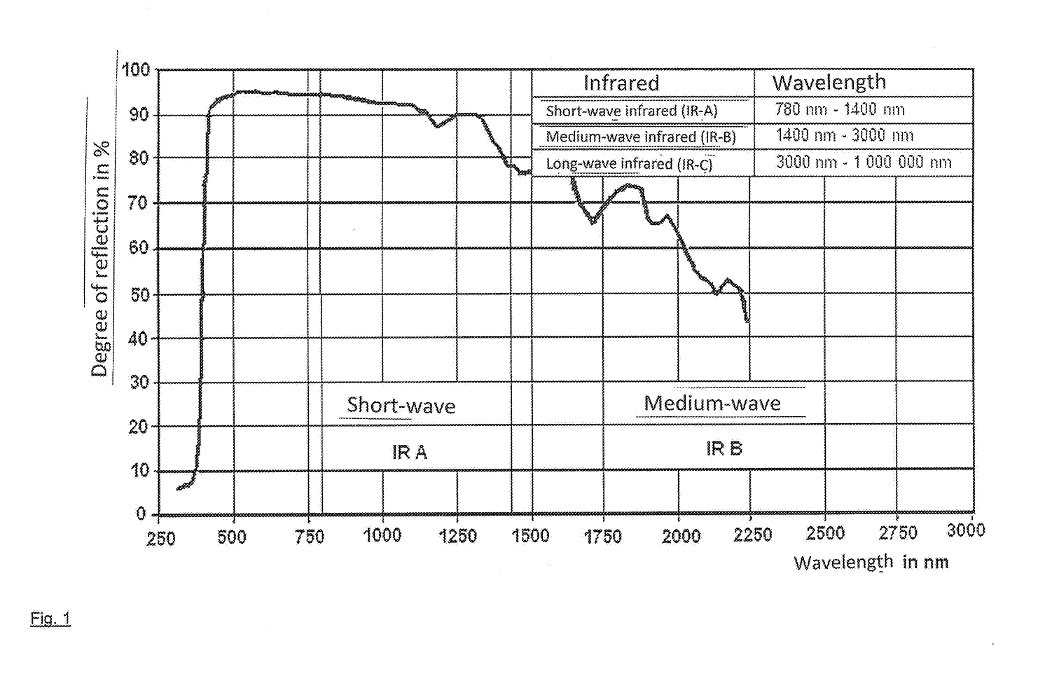

The degree of reflection of this composition is shown in FIG. 1.

The measured wellbeing effect in rooms showed that the combination described of Compositions 1+2 demonstrated the greatest benefit for the room climate and for therapeutic purposes.

1. IR-reflecting composition, comprising:
a mixture of glass systems selected from one or more of hollow glass balls, full glass balls, hollow glass balls coated with silver, full glass balls coated with silver, hollow glass balls coated with aluminum and full glass balls coated with aluminum, and with hollow glass balls or full glass balls coated with both metals, or mixtures of the above systems.

2. The IR-reflecting composition according to claim 1, wherein the composition contains a mixture of hollow glass balls, full glass balls, hollow glass balls coated with silver, full glass balls coated with silver, hollow glass balls coated with aluminum and full glass balls coated with aluminum.

3. The IR-reflecting composition according to claim 1, wherein the uncoated and coated hollow glass balls and full glass balls preferably feature a diameter of 10 to 200 μm.

4. The IR-reflecting composition according to claim 1, wherein the IR-reflecting composition further contains comprises fillers, pigments and/or carrier materials.

5. The IR-reflecting composition according to claim 4, wherein the fillers, pigments and/or carrier materials include one or more of defoamers, binding agents, thickening agents, sheet silicates, titanium oxide, carbonates, silica gel, diatomite, silicates, amphiboles, talcum, kaolin, attaclay, cement, limestone, lime, chalk, loess, clay, dolomite, diatomaceous earth, attapulgite, montmorillonite, bentonite, volcanic ashes, mica, vermiculite, synthetic silicic acids, rice husk ash, amorphous glass structures, amorphous silicic acids and synthetic calcium silicates, aluminosilicates, biominerals (nacre) and anorganic color pigments.

6. The IR-reflecting composition according to claim 1, wherein the hollow glass balls and full glass balls coated with silver and/or aluminum make up a weight proportion of 1 to 75 weight % in relation to 100% of the mixture.

7. The IR-reflecting composition according to claim 1, containing
1 to 20 weight % hollow glass balls with a diameter of 1 to 90 μm;
1 to 20 weight % hollow glass balls coated with silver and a diameter of 10 to 90 μm; and
2 to 25 weight % Titanium dioxide as a filler.

8. The IR-reflecting composition according to claim 7, wherein the IR-reflecting composition contains 1 to 25 weight % calcium carbonate with a grading curve of 10 to 4,000 μm as a filler.

9. The IR-reflecting composition according to claim 1, containing
12.5% hollow glass balls with a diameter of 0.5 to 50 μm;
7.5% hollow glass balls coated with aluminum with a diameter of 0.5 to 50 μm;
1.25% hollow glass balls coated with silver with a diameter of 0.5 to 50 μm;
25% full glass balls with a diameter of 0.5 to 70 μm;
7.5% full glass balls coated with aluminum with a diameter of 0.5 to 70 μm;
3.5% full glass balls coated with silver with a diameter of 0.5 to 70 μm; and
42.75% mica (0.5 to 200 μm).

10. The IR-reflecting composition according to claim 1, containing
8.5% hollow glass balls with a diameter of 0.5 to 170 μm;
12% hollow glass balls coated with aluminum with a diameter of 0.5 to 170 μm;
5% hollow glass balls coated with silver with a diameter of 0.5 to 170 μm;
35% full glass balls with a diameter of 0.5 to 150 μm;
2.5% full glass balls coated with aluminum with a diameter of 0.5 to 150 μm;
5.5% full glass balls coated with silver with a diameter of 0.5 to 150 μm;
10% titanium oxide; and
21.5% mica (0.5 to 200 μm).

11. An IR-reflecting construction material, wherein the construction material features a coating that contains the IR-reflecting composition of claim 1.

12. The IR-reflecting construction material according to claim 11, wherein the coating contains a binding system.

13. The IR-reflecting construction material according to claim 12, wherein the binding system contains binding agents based on acrylate, vinyl acetate or silicon resin, cement, gypsum, gypsum anhydride, a latent hydraulic binding agent, water glass, bitumen, clay, a ceramic binding agent or lignin and its derivatives.

14. The IR-reflecting construction material according to claim 11, wherein the construction materials are selected from one or more of calcium silicate panels, gypsum panels, insulation panels, XPS panels, hard foam panels, Promat panels, gypsum board construction panels GBP, eternit, LUX elements, plasterboard construction panels, KNAUF construction panels, Fermacell, Phonewall panels, KS construction panels, gypsum fiberboard panels, wood panels, wood fiber panels, impregnated gypsum board panels, panels, tiles, WEDI panels, acrylic glass panels, porous concrete panels, brick panels, cement-bonded construction panels, vermiculite panels and perlite panels, foam glass, panels based on regenerative materials (such as bulrush plants or sweet grasses ((poaceae)), bisulfite panels, noise-reducing panels, magnesia binders, asphalt, tar and bitumen.
